(19) United States
(12) Patent Application Publication
(10) Pub. No.: US 2006/0262100 A1
(43) Pub. Date: Nov. 23, 2006

(54) Touch-input active matrix display device

(75) Inventor: Cornelis Van Berkel, Hove (GB)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., Eindhoven (NL)

(21) Appl. No.: 10/569,386

(22) PCT Filed: Aug. 17, 2004
(86) PCT No.: PCT/IB04/02690

§ 371 Date: Feb. 21, 2006

(30) Foreign Application Priority Data
Aug. 23, 2003 (GB) 0319909.8

(51) Int. Cl. G09G 5/00

(52) U.S. Cl. 345/173

(57) ABSTRACT

An active matrix display device having touch input functionality is provided. The device comprises an electrode pattern (11,12,14) supported by a substrate. Electrical currents supplied to the pattern are caused to flow from the electrode pattern to a common electrode (51) via a body located therebetween in response to touch-input to the display at the location of the body. The body may comprise a conductive material (30) for example. The device further comprises current-measuring means (52,53;54) connected to the common electrode in at least two spaced locations, the means operable to measure currents resulting from the touch-input so as to enable determination of the respective location of said touch-input in at least one dimension. By measuring the current at various locations on the common electrode, simple geometric-based calculations can be employed to determine the location of touch-input to the display.

The invention relates to a display device having touch input functionality and especially to an active matrix display device comprising an electrode pattern supported on a substrate and a common electrode spaced from and overlying the electrode pattern. In particular, the invention relates to the sensing of touch input.

The use of touch-input display devices is becoming increasingly common in today's society in which quick and easy user-interaction with displayed information is desirable. Such display devices may be employed as part of public information sources, in control devices for large machinery, and in small hand-held devices such as mobile phones and PDAs for example. Touch-input functionality integrated onto a display can remove the requirement for peripheral user-input devices such as a mouse and/or a keyboard thus making the overall apparatus less cumbersome.

For the purposes of this specification, the term “touch-input” will include user-input to a display device from a user's finger, a stylus, pen or other such apparatus which touches a display device and applies pressure at a point.

Various display types are suitable for integration with touch-input displays. Flat panel type displays are particularly versatile as they are relatively lightweight and can be incorporated into small devices such as PDAs. Examples of flat panel displays include active matrix displays such as active matrix liquid crystal displays (AMLCDs), active matrix LED (AMPLED) displays and electrophoretic displays. Another benefit of flat panel displays having touch-input functionality is the close proximity of the drive electronics to the touch-input sensors thereby allowing short interconnections therebetween. By way of example, one approach has been to position a transparent sensor array over the display surface. In this case, touch-input to the sensor array is outputted via connections from the edge of the sensor array.

However, by placing the sensor array in the viewing path of the user in this way, the quality of the viewed image is often reduced. Issues concerning dirt particles becoming trapped between the two bonded surfaces make this approach unfavourable.

U.S. Pat. No. 5,610,629 discloses a system for pen-input to a liquid crystal display, wherein each pixel in the display has an associated sensor which responds to signals produced by a hand-held stylus. An example type of sensor disclosed is a piezoelectric sensor positioned beneath respective pixel cells. In this, a polyvinyl difluoride (PVDF) film is disposed between crossing sets of conductors. When the film is depressed at a point by the stylus, a voltage is created between crossing conductors at that point. This is detected via an associated sense line which is separate from the associated column address line.

EP-0,773,497 discloses a touch sensitive LCD wherein each LC cell performs the sensing function of the device. Touch-input to a pixel changes the capacitance of that cell which changes the charging characteristics. These characteristics are measured to detect touch-input. However, such changes in capacitance are relatively small and these can be difficult to detect with relatively high noise levels which are created by a constantly changing cell capacitance caused by the movement of the LC cells.

The Applicant's co-pending, unpublished European patent application, number EP03101085.3 (Our ref: PHNL030393), filed on 18^{th} Apr. 2003, describes a flat display device having a display area and an electrically controlled input device such as a touch-pad. Separate conductor patterns are formed for controlling the display area and for transmitting input information from the input device. Information input is realised by applying a pressure on the selected area constituting the input device, so that electrical contact is established between two opposing substrates. Conducting particles can be arranged between the two substrates to allow the electrical contact therebetween.

The present invention seeks to provide an active matrix display device with integrated touch-input functionality.

The present invention seeks to provide a simple method of sensing touch-input to an active matrix display device.

According to the present invention there is provided an active matrix display device having touch input functionality and comprising an electrode pattern supported by a substrate, said pattern comprising a plurality of electrodes to which electrical current is supplied, a common electrode spaced from and overlying the electrode pattern, and a plurality of bodies disposed between the electrode pattern and the common electrode which electrically connect the common electrode to an electrode in the pattern in response to touch-input at the locations of the respective body, wherein the device further comprises current-measuring means connected to the common electrode at at least two locations, said means operable to measure currents resulting from a touch-input so as to enable determination of the respective location of the touch-input in at least one dimension in the plane of the common electrode.

According to a second aspect of the present invention there is provided a method of sensing touch-input to an active matrix display device comprising an electrode pattern supported on a substrate and a common electrode spaced from and extending over the electrode pattern, the method comprising the steps of:
supplying an electrical current to the electrode pattern;
measuring the current flow on the common electrode in at least two locations so as to enable determination of the location of touch-input to the display in at least one dimension in the plane of the common electrode.

Touch-input to the display causes a current to flow from the electrode pattern via the bodies to the common electrode. Therefore, by sensing the current at locations on the common electrode, the location of touch-input to the display can easily be detected. Simple triangulation techniques can be employed for example in which the currents measured at respective points are compared in order to establish the location of the current source on the common electrode in at least one dimension. Advantageously, no additional components are required for conventional active matrix pixel circuitry or for the driver circuitry.

Each of the bodies may comprise a pressure-sensitive element having an electrical resistance which changes in response to applied pressure. A piezoresitive material having suitable electrical characteristics can be used therefore. The pressure-sensitive element preferably overlies and directly contacts an electrode in the pattern. This element may be formed lithographically for example and serve as a spacer member between the electrode pattern and the common electrode to maintain a well defined gap therebetween.

Alternatively, the body may comprise a conducting material and be disposed between the pixel electrode and the common electrode. Each are preferably a conducting body formed lithographically and each having a diameter which is less than the electrode spacing, and is positioned between the opposing electrodes. Therefore, when pressure is applied to the common electrode in response to touch-input, the spacing between the electrodes is reduced causing the conducting bodies to electrically connect the common electrode to the underlying electrode in the pattern at the location of pressure-application.

In a preferred embodiment of the invention, the electrode pattern comprises a set of select conductors, a set of data conductors, and a row and column array of pixel electrodes to which data voltages can be supplied by an associated data conductor via a respective thin film transistor having a main terminal connected to the pixel electrode, and a gate terminal connected to an associated select conductor to which gate voltages can be applied to control the supply of data voltages to the respective pixel electrode. For the purposes of this specification, the term “main terminal” will include the source or drain terminals of a transistor. Driver circuitry is connected to each data conductor for supplying data voltages to associated pixels during respective address periods, and for supplying touch-sensing voltages to associated pixels during respective sensing periods. These voltages serve to cause a current to flow to the common electrode via at least one of the bodies in response to touch-input at the location of those bodies.

Preferably, the driver circuitry comprises a respective column buffer connected to each data conductor for supplying said data voltages, and a touch buffer for supplying said touch-sensing voltages. The touch buffer may be switchably connected to a plurality of the data conductors and may even serve as a dedicated buffer connected to all of the data conductors. All pixel electrodes in a row can then be supplied with the same data voltage. This enables accurate and well determined touch-input detection during a respective sensing period. Differing data voltages on the pixel would otherwise lead to non-uniform measured currents.

Advantageously, by integrating the touch sensing onto the pixel electrodes of an active matrix display, the requirement for extra conductors on the substrate to perform the touch-input detection is eliminated. The inclusion of current-measuring means is relatively simple and easy to incorporate into a conventional active matrix display device.

The current measuring means may simply include two elongate electrodes disposed along opposing edges of the common electrode. For example, the electrodes could be disposed vertically down the left- and right-hand edges of the display area. With such an arrangement, the horizontal position of any touch-input can be obtained simply from measuring the current through the respective electrodes. The vertical position can be determined from knowing the position of the selected row, i.e. the source of the measured current.

Alternatively, for a rectangular display having a substantially rectangular common electrode, the current-measuring means may include four electrodes each disposed at a respective corner of the common electrode. Simple triangulation techniques can then be employed to determine touch-input position in both the horizontal and vertical direction. Advantageously, this arrangement allows the current-measuring means to function independently of the driver circuitry.

Embodiments of the invention will now be described by way of example with reference to the accompanying drawings, in which:

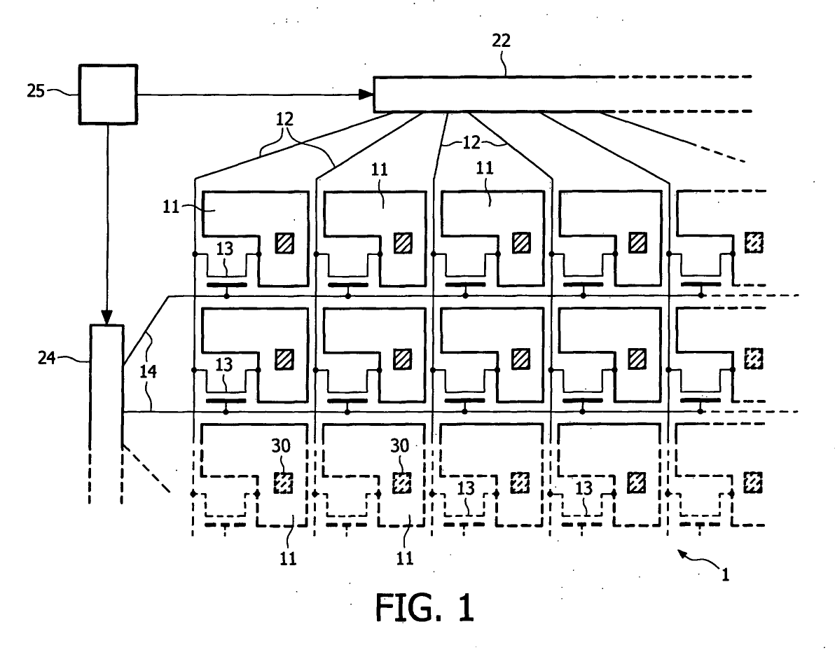

FIG. 1 shows schematically part of an active matrix display device in accordance with the present invention;

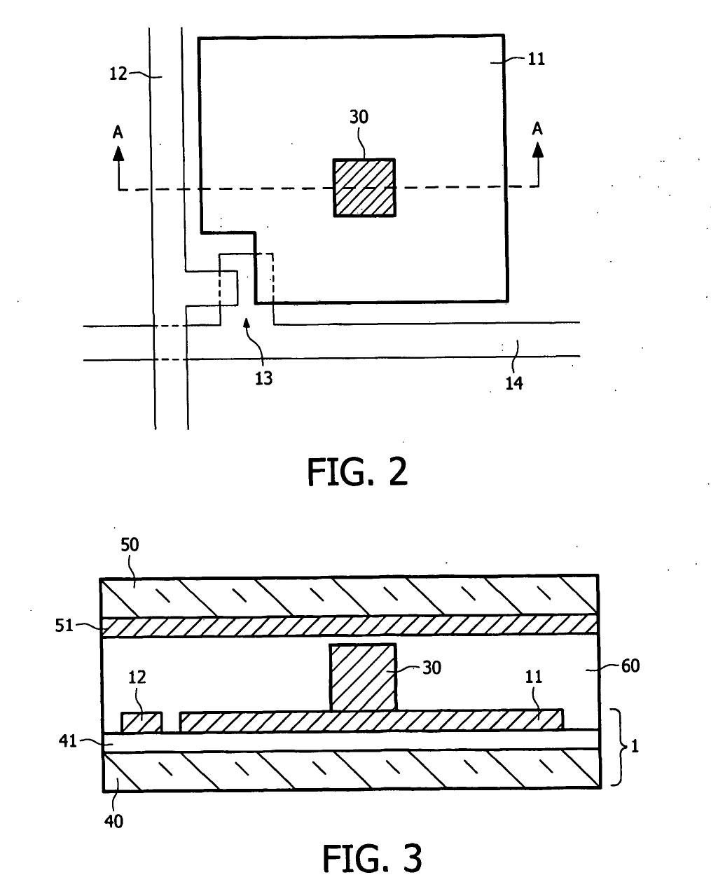

FIG. 2 is a plan view of a touch-sensitive pixel in a first embodiment of the invention;

FIG. 3 is a cross-sectional view along the line A-A of the pixel shown in FIG. 2;

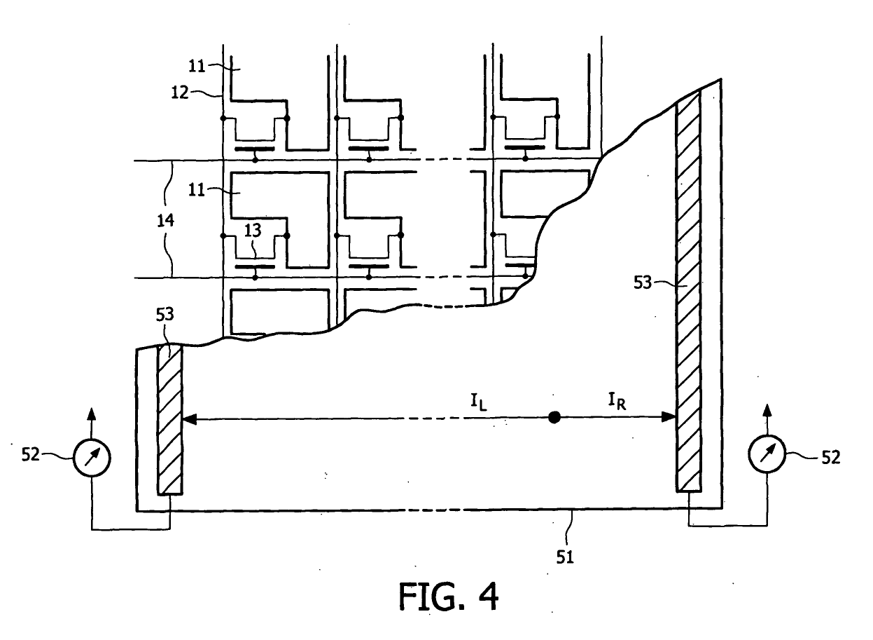

FIG. 4 is a plan view of the electrode layout of an active matrix display device of the first embodiment;

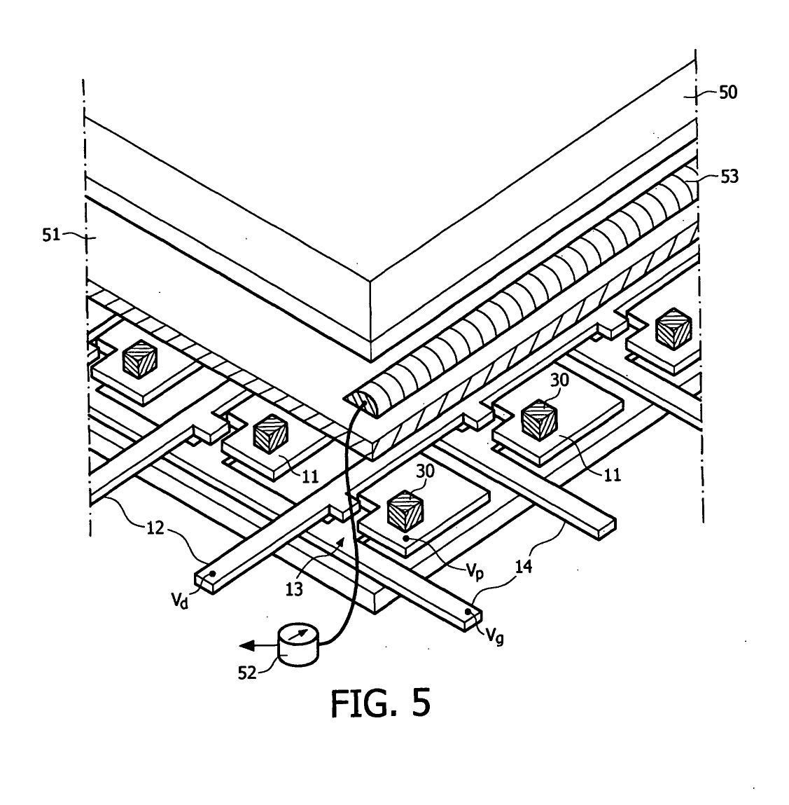

FIG. 5 is a perspective view of one corner of an active matrix display device of the first embodiment, shown in expanded form;

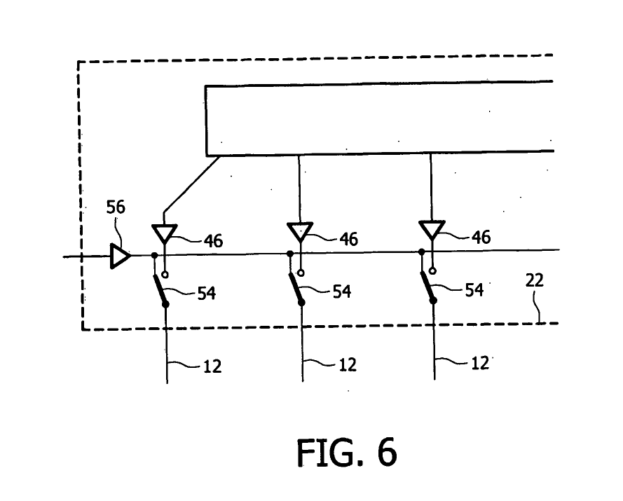

FIG. 6 shows schematically a part of the driver circuitry of the first embodiment;

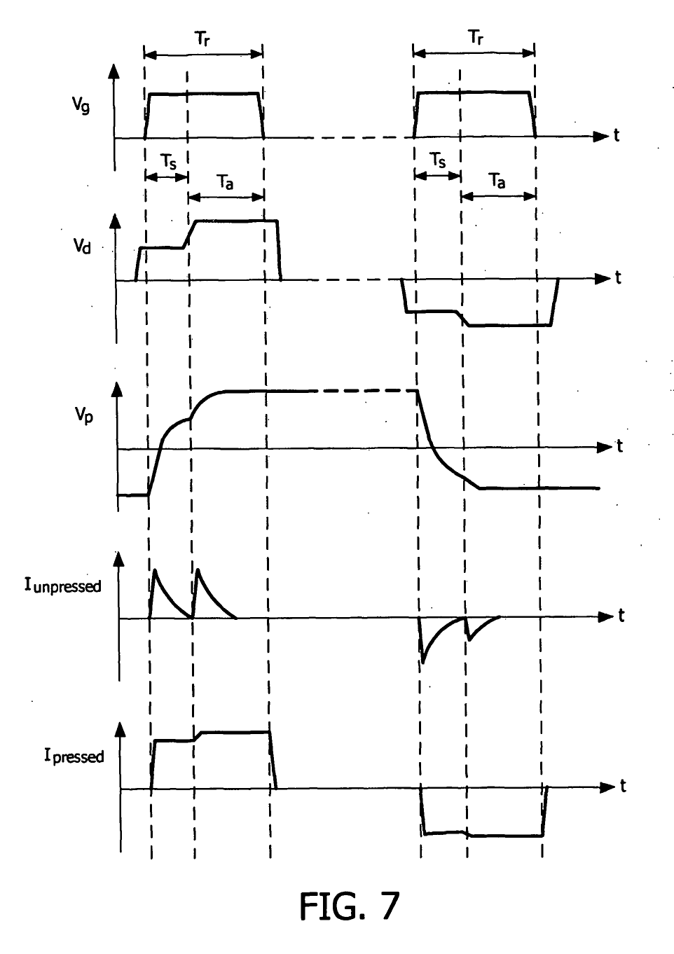

FIG. 7 shows a voltage-time chart for various voltage signals present in the device of the first embodiment during use;

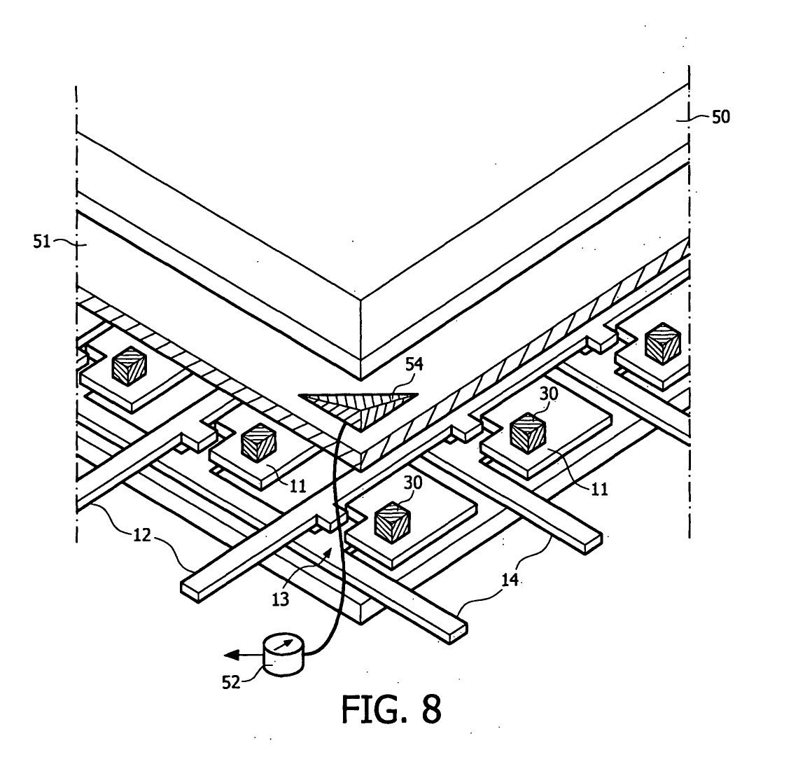

FIG. 8 is a perspective view of one corner of an active matrix display device of a second embodiment, shown in expanded form;

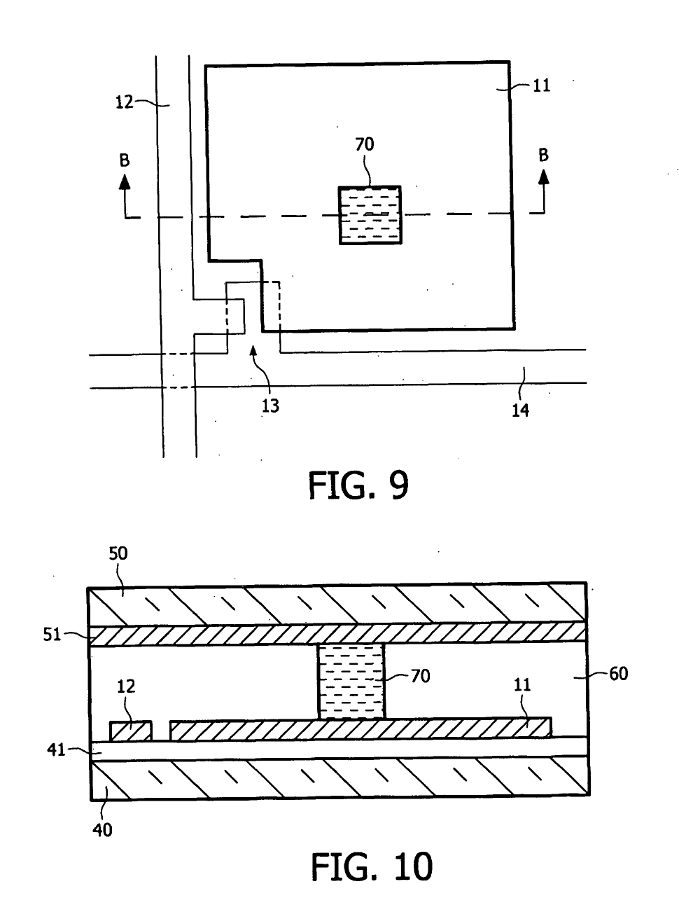

FIG. 9 shows a plan view of an alternative touch-sensitive pixel in accordance with the present invention; and,

FIG. 10 is a cross-sectional view along the line B-B of the pixel shown in FIG. 9.

It should be noted that the figures are diagrammatic and not drawn to scale. Relative dimensions and proportions of parts of these figures have been shown exaggerated or reduced in size, for the sake of clarity and convenience in the drawings. The same reference numbers are used throughout the Figures to denote the same or similar parts.

The present invention is applicable to various active matrix display devices. The following specific embodiments will describe the invention in relation to an active matrix liquid crystal display (AMLCD) device having a row and column array of pixels by way of example only. It will be appreciated that other types of display device can be employed.

FIG. 1 shows schematically an active plate 1 for an AMLCD device having touch input functionality. The active plate 1 comprises an electrode pattern supported by a substrate (not shown). The pattern includes a row and column array of pixel electrodes 11 to which data voltages can be supplied by an associated data conductor 12 via a respective thin film transistor (TFT) 13. Each TFT has a drain terminal connected to the pixel electrode 11 and a gate terminal connected to an associated select conductor 14. Gate voltages are applied to each select conductor 14 to control the supply of data voltages to the respective pixel electrode 11. The pixels are addressed with data voltages by turning on, or selecting, in this way, the TFTs 13 one row at a time during respective address periods.

An electrode pattern is therefore provided and supported on a substrate (not shown), the pattern comprising a set of select conductors 14, a set of data conductors 12, and a row and column array of pixel electrodes 11.

The pixel electrodes 11, data conductors 12, select conductors 14 and the TFTs 13 of the active plate 1 are formed on a substrate using conventional thin film processing techniques involving the deposition and photolithographic patterning of various insulating, conducting and semiconducting layers, for example by a CVD process.

The AMLCD device of FIG. 1 also comprises a passive plate (not shown) which overlies the active plate I and sandwiches a layer of liquid crystal (LC) material therebetween. On it's inner surface the passive plate carries a common electrode which is continuous across the area of the display. The common electrode, which is spaced from and overlies the electrode pattern, is operable to create an electrical potential between itself and each pixel electrode 11. This potential serves to modulate the transmissivity of the LC material sandwiched therebetween.

Each pixel further comprises a body disposed between the pixel electrode 11 and the common electrode which electrically connects the common electrode to one of the pixel electrodes 11 in response to touch-input to that pixel.

Voltages generated by the driver circuitry create an electrical potential between a pixel electrode and the common electrode. When the connection is made therebetween in response to touch-input, a current flows between the pixel electrode and the common electrode via the body.

FIG. 1 shows each body as a lithographically-defined conductive body 30 in accordance with a first embodiment of the invention which will now be described in more detail with reference to FIGS. 2 to 7.

FIG. 2 shows, in plan-view, a touch-sensitive pixel of the first embodiment. The TFT 13 shown is a bottom-gate type by way of example only. Only the electrode pattern of the pixel is shown for ease of understanding. At least one insulating layer (not shown) is present between the underlying select conductor 14 and the data conductor 12 to serve as a crossover dielectric. Similarly, the source and drain electrodes of the TFT 13 are insulated from the gate electrode by a gate dielectric (not shown) which may be provided by the same layer as the crossover dielectric.

FIG. 3 is a cross-sectional view of the pixel along the line A-A shown in FIG. 2 intersecting the data conductor 12, the pixel electrode 11 and the conductive body 30. The substrate 40 of the active plate can be seen in FIG. 3 with the crossover dielectric 41 disposed thereon.

A second substrate 50 is spaced from the active plate 1. The common electrode 51 is carried on the inner surface of the second substrate 50 and extends over the area of the display so as to form a second electrode for every pixel in the array. Together with other layers (not shown), such as a colour filter, a polariser and an alignment layer, the substrate 50 and common electrode 51 form the passive plate.

The conducting body 30 is disposed between the pixel electrode 11 and the common electrode 51. During manufacture, the body is formed on the pixel electrode using lithographic definition, having a thickness which is less than that of the cell gap, and is preferably formed of a conducting polymer composite material. Examples of such materials can be found at www.zipperling.de/Research and include a mixture of a non-conductive polymer binder and polyaniline, a conductive polymer. The body is shaped as a cuboid although it is envisaged that the conductive material could also be used to form various different shaped bodies such as pyramid-shaped. The gap between the top of the body and the common electrode 51 may vary and will depend on the flexibility of the substrate 50 for example.

Instead of the lithographically defined bodies 30 described above, conductive spheres could instead be formed of a conducting polymer and having a diameter which is less than that of the cell gap. It will also be appreciated that the lithographically defined bodies could instead be formed on, and therefore contact, the common electrode 51 during manufacture. In this case, upon touch-input to the pixel, the conductive body 30 would be caused to contact the underlying pixel electrode 11. Alternatively, the body can be formed of an insulating polymer and then coated with a conducting polymer.

Touch-input to the pixel applies pressure to the second substrate 50. This pressure causes the substrate 50 to bend such that the cell gap (the separation between the pixel electrode 11 and the common electrode 51) reduces. If enough pressure is applied, the common electrode 51 touches the conducting body 30 so that electrical connection is made between the pixel electrode 11 and the common electrode 51 via the conducting body 30.

With reference to FIGS. 4 and 5, the display device further comprises current-measuring means connected to the common electrode 51 in two spaced locations. The current-measuring means is operable to measure currents I_{L}, I_{R} resulting from touch-input so as to enable determination of the respective location of the touch-input in the horizontal direction.

The current measuring means in this first embodiment comprises current probes 52 connected to respective elongate electrodes 53 disposed along opposing edges of the common electrode 51. The electrodes 53 are formed of a low resistance material such as chromium and, in this example, are bonded to the inner surface of the common electrode. FIG. 5 shows a perspective view of one corner of the display device with the stack of layers expanded in the vertical direction for clarity.

The common electrode 51 has a finite resistance across its planar area. When a current is caused to flow from the electrode pattern to the common electrode 51 via the conductive body 30 in response to touch-input, each elongate electrode 53 will detect a current which is dependant on the distance from the point of touch-input to that electrode 53. These currents are referenced as I_{L} and I_{R} in FIG. 4. The currents measured by each corresponding probe 52 are then compared in order to determine the position of the touch-input in the horizontal direction. For example, if the display is touched at the centre of the display area, equal currents will flow to each of the elongate electrodes 53. These currents are then detected, measured and compared by the current probes 52. If the current measured by the left probe I_{L} is 50 mA and the current measured by the right probe I_{R} is 50 mA, then the ratio I_{L}/I_{R} is 1. This indicates that the touch-input is somewhere along a vertical line in the centre of the display area. A ratio of <1 would indicate that touch-input has occurred towards the left of the display. A ratio of >1 would indicate touch-input towards the right of the display.

The addressing of the display device of the first embodiment will now be described. The array of pixels is addressed one row at a time during respective row periods as with conventional active matrix addressing schemes. However, each row period is divided into a sensing period and an address period. For the duration of each row period, a row of pixels is selected by applying a gate voltage to the associated select conductor 14. Referring again to FIG. 1, the device further comprises driver circuitry connected to each data conductor 12 for supplying touch-sensing voltages to associated pixel electrodes during respective sensing periods, and for supplying data voltages to the associated pixel electrodes 11 during respective address periods. By applying voltages to the pixel electrodes, a current flows therefrom to the common electrode 51 via at least one of the conductive bodies 30 in response to touch-input at the location of those conductive bodies 30.

The driver circuitry is carried on the active plate 1 and includes a column driver 22 and a row driver 24. Video data signals and control signals are supplied to the driver circuitry by a control unit 25. The column driver 22 is connected to each data conductor 12 at one end thereof. The row driver 24 is connected to each select conductor 14. It will be appreciated that the driver circuitry can be formed of TFTs on the substrate of the active plate or formed of ICs connected to the row and column array via a series of connections.

Part of the column driver 22 is shown in more detail in FIG. 6. The column driver 22 comprises a respective column buffer 46 connected to each data conductor 12 for supplying the data voltages, and a touch buffer 56 for supplying the touch-sensing voltages. The touch buffer 56 is switchably connected to all of the data conductors 12 by a respective switch 54 connected to each data conductor 12.

FIG. 7 shows various voltage and current levels present on parts of the address circuitry associated with the corner pixel shown in FIG. 5. The gate voltage V_{g} is high for the row period Tᵣ. This is generated by the row driver 24 and applied to the gate terminal of the TFT 13 via the select conductor 14 causing the TFT to turn on. This allows any voltage V_{d} present on the data conductor 12 to be applied to the pixel electrode via the TFT 13. Due to the relatively large capacitance of the pixel cell, the voltage on the pixel electrode Vₚ gradually increases throughout the row period Tᵣ until it reaches the voltage V_{d} on the data conductor 12.

If the pixel is not pressed (no touch-input), then the current flowing on the data conductor 12 decreases throughout the row period Tᵣ as the pixel electrode voltage approaches the voltage on the data conductor 12, with the current I tending to zero towards the end of the row period Tᵣ. However, if the pixel is pressed, the pixel voltage Vₚ does not increase and current flows from the pixel electrode 11 to the common electrode 51 for the duration of the row period Tᵣ. The finite on-resistance of the TFT (in the mega ohms range) ensures that the current flowing on the data conductor upon touch-input is not excessively high.

The current supplied by the address circuitry flows to the elongate electrodes 53 via the electrode pattern, the conductive body 30 and the common electrode 51. The current received by each of the two elongate electrodes 53 depends on the location of the touch-input.

By addressing each row of pixel electrodes 11 during respective row periods, the location of the touch-input in the vertical direction can be determined at any given time. For example, if touch-input is detected during the row period for row N, then it can be assumed that the location of the touch-input is somewhere along a horizontal line overlying the pixel electrodes associated with row N. This knowledge can then be combined with the location in the horizontal direction determined from the measured currents in order to establish a 2D coordinate for the location of the touch-input.

The row period Tᵣ comprises a sensing period Tₛ and an address period Tₐ as shown in FIG. 7. During the sensing period Tₛ, all of the pixels in the selected row are driven with a voltage of the same magnitude which is supplied by the touch buffer 56. During the address period Tₐ, the pixels are addressed with their respective data voltages which are generated by the respective buffers 46. Therefore, the image data is displayed on the addressed pixels at the end of the address period Tₐ and remains until the next row period Tᵣ for the associated row of pixels.

Throughout the addressing of the array of pixels, inversion schemes may be employed to periodically invert the polarity of the driving voltages which are applied to the pixel electrodes. Such schemes are well known and serve to reduce aging effects caused by a continuous DC (Direct-current) voltage being applied across LC cells. The polarity of the data conductor voltage can be seen to alternate on the respective graph of FIG. 7.

At the start of the row period Tᵣ the switch 54 connects the touch buffer 56 to all of the data conductors 12. With the TFTs 13 of each pixel in the selected row turned on, the voltage generated by the touch buffer 56 is applied to each pixel electrode 11 in that row. The voltage on each pixel Vₚ takes a short period to reach the applied voltage.

It can be seen from FIG. 7 that the current I_{unpressed} which flows through each data conductor 12 when there is no touch-input to the associated pixel falls to zero towards the end of the sensing period Tₛ. However, when there is touch-input to the associated pixels, there is a connection between the pixel electrode 11 and the common electrode 51, and so a steady current I_{pressed} flows through the associated data conductor 12. This current I_{pressed} is dependant on the voltage applied to the pixel electrode 11.

The purpose of the independent touch buffer, and a sensing period separate from the address period, is too eliminate variation in the current flow to the common electrode 51 which would be caused by the varying magnitude of data signals which correspond to varying brightness of image output. Such uncertainty in the current to the common electrode may affect the relative noise levels and place stronger demands on the dynamic range of the current probes 53 when detecting touch-input. In addition, the buffer ICs 46 for each column may not be capable of generating the currents demanded when touch-input occurs.

The voltage generated by the touch buffer 56 is preferably in the middle of the data voltage range. This will normally drive each pixel to a mid-grey output. Advantageously, this reduces the voltage change on the pixel when addressed with the data signal corresponding to the output image.

At the end of each sensing period Tₛ, the measurements taken by the current probes are processed. With only two electrodes 53, the processing requires only the calculation of the ratio of the two measured currents from the left and right sides respectively. It will be appreciated, however, that more than two electrodes positioned around the common electrode 51 can be employed. In such a case, the processing to determine the location of any touch-input may be more complex.

The switches 54 then connects the buffers 46 to their respective data conductors 12 for the address period Tₐ which lasts for the remainder of row period Tᵣ. The pixel electrodes 11 are supplied with data voltages corresponding to an output image during the address period. Each data voltage sets the required greyscale of the designated pixel. At the end of the address period Tₐ the gate voltage is removed from the select conductor 14 associated with that row thereby leaving the LC charged with the applied data voltage until the next respective row period.

Each row of pixels is addressed in turn and during respective row periods in a conventional manner. The sequence of addressing the pixels one row at a time repeats so that the image displayed on the device is refreshed periodically. Touch-input to the display is sensed throughout operation during respective sensing periods which each precede an address period.

In a second embodiment of the invention, the common electrode is substantially rectangular and the current-measuring means comprises four electrodes each disposed at a respective corner of the common electrode. This is illustrated in FIG. 8. Each corner electrode 54 is formed of a low resistance conductive material, such as aluminium, and is coupled to the common electrode 51 at respective corners of the rectangular display. In a similar manner to that of the first embodiment, a current probe 52 is connected to each corner electrode 54 and serves to measure the current flowing there through.

The same addressing scheme as the first embodiment can be applied to the second embodiment. Currents which flow through the respective corner electrodes 54 are measured and compared. Simple triangulation techniques and calculations can then be applied to determine the position of the touch-input as a 2D coordinate in the plane of the common electrode 51. Examples of such techniques are described in US patent no. U.S. Pat. No. 5,365,461 whose contents are incorporated herein by reference.

The detection and measurement of the currents which flow on the common electrode as a result of touch-input can be integrated with the drive scheme employed. This was the case as described in the first embodiment with reference to FIG. 7. However, the electrode arrangement of the second embodiment advantageously enables a 2D coordinate to be determined purely from the current measurement. That is to say, the knowledge of which row of the array being addressed at a given time is not required. Therefore, the current sensing means of the second embodiment could be incorporated into a display device without the need to integrate with the existing drive scheme making the touch-sensing circuitry independent of the driver circuitry. It will be appreciated however, that this electrode arrangement can be integrated with the driver circuitry in a similar manner to that of the first embodiment.

Although the touch-input sensing has been described as occurring every row period, variations in the rate of touch-input sensing and the manner in which it is carried out are envisaged. For example, the detection could be carried out less frequently, thereby allowing the display device to perform solely in a display mode until touch-input detection is required. Alternatively, current measurements can be made during the row periods corresponding to particular and/or predetermined rows. These may be rows which display specific buttons for a user to touch for example.

The described embodiments refer to current measuring means as having two or four electrodes arranged on the common electrode. It will be appreciated that any reasonable number of electrodes can be employed providing they are connected to the common electrode in at least two spaced locations. For example, an arrangement of three electrodes can be envisaged wherein they are connected to the common electrode in a triangular fashion.

By way of example, the bodies disposed between the electrode pattern and the common electrode in the described embodiments have been conductive spheres 30. An alternative touch-sensitive pixel arrangement will now be described with reference to FIGS. 9 and 10. Instead of the body comprising a conducting sphere, each pixel comprises a pressure-sensitive element 70 having an electrical resistance which changes in response to applied pressure. The pressure-sensitive element 70 is formed of a piezoresistive material which has a resistance which is dependant on the fractional compression of the material. When pressure is applied to such a material, the resistance decreases significantly.

FIG. 9 shows a plan view of the pixel layout wherein the pressure-sensitive element 70 is disposed on and near the centre of the pixel electrode 11. The actual position of the pressure-sensitive element 70 on the pixel electrode is not critical however. FIG. 10 shows a cross-sectional view of the pixel along the line B-B of FIG. 9 which intersects the pressure-sensitive element 70.

Following the formation of the pixel electrodes 11 and the data conductors 12, respective pressure-sensitive elements 70 are formed by lithographic definition on the pixel electrodes 11 of each pixel. It is envisaged that the piezoresistive material may be UV curable. In this case, the piezoresistive material is spincoated as a layer, having a thickness which is equal to that of the intended cell gap, over the active plate. The layer is then exposed to UV through a mask leaving the individual pressure-sensitive elements 70. It can be seen from FIG. 10 that the pressure-sensitive element 70 of each pixel makes contact with the common electrode 51 through the LC material 60. When no pressure is applied to the pixel via the passive plate (no touch-input) the pressure-sensitive element 70 should have a very high resistance, in the order of >10¹² ohms. In response to touch-input to the pixel, the resistance of the pressure-sensitive element 70 reduces significantly to a value which is much less than the ON-resistance of the TFT 13, in the order of <10⁶ ohms thereby making an electrical connection between the pixel electrode 11 and the common electrode 51. An example polymer material having these properties is described in US patent number U.S. Pat. No. 6,291,568 to which reference is invited.

The above-described embodiments have comprised a touch-input AMLCD device. However, it is envisaged that other types of active matrix display devices can be employed to enable the invention. These include electrophoretic displays which comprise a fluid layer that supports ink capsules. This layer is sandwiched between the active and passive plates in a similar manner to the LC layer 60 of the AMLCD devices described above. When a pixel is pressed, for example, the touch action's compressive force can be transferred to a pressure-sensitive element disposed on the pixel electrode through the ink capsules.

Although the bodies of the above-described embodiments have been located on the pixel electrodes 11, it is envisaged that they could instead be disposed on other parts of the electrode pattern, providing that there is a current supplied to that part of the pattern. For example, with reference to FIG. 5, lithographically-defined conductive bodies could instead be formed on the data conductors 12. Voltages applied to these conductors would generate a current flow through to the common electrode 51 in response to touch-input to that pixel. The location of this touch-input would be detectable in accordance with the invention.

In summary, an active matrix display device having touch input functionality is provided. The device comprises an electrode pattern 11, 12, 14 supported by a substrate. Electrical currents supplied to the pattern are caused to flow from the electrode pattern to a common electrode 51 via a body located therebetween in response to touch-input to the display at the location of the body. The body may comprise a conductive material 30 for example. The device further comprises current-measuring means 52,53;54 connected to the common electrode in at least two spaced locations, the means operable to measure currents resulting from the touch-input so as to enable determination of the respective location of said touch-input in at least one dimension. By measuring the current at various locations on the common electrode, simple geometric-based calculations can be employed to determine the location of touch-input to the display.

From reading the present disclosure, other variations and modifications will be apparent to persons skilled in the art. Such variations and modifications may involve equivalent and other features which are already known in the art and which may be used instead of or in addition to features already described herein.

1. An active matrix display device having touch input functionality and comprising an electrode pattern supported by a substrate, said pattern comprising a plurality of electrodes to which electrical current is supplied, a common electrode (spaced from and overlying the electrode pattern, and a plurality of bodies disposed between the electrode pattern and the common electrode which electrically connect the common electrode to an electrode in the pattern in response to touch-input at the locations of the respective body, wherein the device further comprises current-measuring means connected to the common electrode at at least two locations, said means operable to measure currents resulting from a touch-input so as to enable determination of the respective location of the touch-input in at least one dimension in the plane of the common electrode.

2. A device according to claim 1, wherein said electrode pattern comprises a set of select conductors, a set of data conductors and a row and column array of pixel electrodes to which data voltages can be supplied by an associated data conductor via a respective thin film transistor having a main terminal connected to the pixel electrode, and a gate terminal connected to an associated select conductor to which gate voltages can be applied to control the supply of data voltages to the respective pixel electrode.

3. A device according to claim 2, further comprising driver circuitry connected to each data conductor for supplying data voltages to associated pixel electrodes during respective address periods and for supplying touch-sensing voltages to associated pixel electrodes during respective sensing periods, said touch-sensing voltages serving to cause a current to flow to the common electrode via at least one of said bodies in response to touch-input at the location of those bodies.

4. A device according to claim 3, wherein said driver circuitry comprises a respective column buffer connected to each data conductor for supplying said data voltages, and a further buffer 6for supplying said touch-sensing voltages.

5. A device according to claim 4, wherein said further buffer is switchably connected to a plurality of said data conductors.

6. A device according to claim 1, wherein said current-measuring means includes two elongate electrodes disposed along opposing edges of the common electrode.

7. A device according to claim 1, wherein said common electrode is substantially rectangular and said current-measuring means includes four electrodes each disposed at a respective corner of the common electrode.

8. A device according to claim 1, wherein each of said bodies comprises a pressure-sensitive element having an electrical resistance which changes in response to applied pressure.

9. A device according to claim 1, wherein each of said bodies comprises a conducting material and is disposed between the electrode pattern and said common electrode.

10. A method of sensing touch-input to an active matrix display device comprising an electrode pattern supported on a substrate and a common electrode spaced from and extending over the electrode pattern, the method comprising the steps of:
supplying an electrical current to the electrode pattern;
measuring the current flow on the common electrode in at least two locations so as to enable determination of the location of touch-input to the display in at least one dimension in the plane of the common electrode.

11. A method according to claim 10, wherein said electrode pattern comprises a set of select conductors a set of data conductors, and a row and column array of pixel electrodes each pixel electrode being addressable by data voltages supplied by an associated data conductor when selected by a gate voltage supplied by an associated select conductor, the method further comprising the step of:
addressing each row of pixel electrodes during respective row periods and,
determining the location of said touch-input in a dimension substantially perpendicular to the selected row of pixels in accordance with the location of a selected row.

12. A method according to claim 10, wherein said electrode pattern comprises a set of select conductors a set of data conductors and a row and column array of pixel electrodes each pixel electrode being addressable by data voltages supplied by an associated data conductor when selected by a gate voltage supplied by an associated select conductor, the method further comprising the step of:
addressing each row of pixel electrodes during respective row periods each row period comprising a sensing period and an address period
supplying all pixel electrodes in a row with the same voltage and measuring said current on the common electrode during a respective sensing period, and
supplying the pixel electrodes with data voltages corresponding to an output image during said address period.
